(19) United States
(12) Patent Application Publication
(10) Pub. No.: US 2009/0126114 A1
(43) Pub. Date: May 21, 2009

(54) MOBILIZATION HANDRAIL AND BED EQUIPPED WITH THIS MOBILIZATION HANDRAIL

(76) Inventors: Jiri Kral, Roudnice nad Labem (CZ); Michal Salus, Roudnice nad Labem (CZ); Zbynek Frolik, Slany (CZ)

Correspondence Address: HOVEY WILLIAMS LLP, 10801 Mastin Blvd., Suite 1000, Overland Park, KS, 66210, US

(21) Appl. No.: 11/720,487

(22) PCT Filed: Nov. 14, 2005
(86) PCT No.: PCT/CZ2005/000085

§ 371 Date: Jun. 19, 2007

(30) Foreign Application Priority Data
Nov. 30, 2004 (CZ) PUV 2004-16035

(51) Int. Cl. A61G 7/00; A61G 7/053; A61G 7/05

(52) U.S. Cl. 5/611; 5/662; 5/600

(57) ABSTRACT

A mobilization handrail (1, 2) which is controlled by a patient without the need for help of medical staff, includes an elongated profile (5). The elongated profile (5) is placed in a guide (4) for inserting and drawing-out of the elongated profile (5) into and from the space underneath the loading surface of the bed (3) while the elongated profile (5) is arranged for positioning in a substantially vertical position after its drawing-out from the space under the loading surface of the bed (3), and it is equipped with a locking device (13) for stabilization in this position.

### TECHNICAL FIELD

The invention relates to a mobilization handrail controlled by a patient without help of hospital staff and to a bed equipped with this mobilization handrail that is hidden under the loading surface of the bed when it is in non-functional position.

### BACKGROUND ART

Majority of standard beds known up to the present that are designated for hospital facilities, for social and senior care or possibly for home patient-care, are not equipped with mobilization handrails. When beds are equipped with handrails, the arrangement has substantial imperfection in the fact that a patient alone cannot control the handrail. It means that such a handrail does not carry out the function expected from it, i.e. to exclude assistance of hospital staff. Handrail designed in this way does not serve for mobilization of a patient by enabling him to get up and stand on his feet by himself, without any assistance of hospital staff, when leaving the bed.

### DISCLOSURE OF INVENTION

The above outlined disadvantages are eliminated by mobilization handrail according to the invention. The mobilization handrail is controlled by the patient self, without any assistance of hospital personnel. Mobilization handrail comprises of an elongated profile. The core of the invention is based on the elongated profile placed in a guide that allows the elongated profile to slide in and slide out of the space under the loading surface of the bed. When the elongated profile is in slide-out position from the space underneath the loading surface of the bed, it is turned and set into nearly a vertical position. It is then fixed in this position by a lock.

It is advantageous, when the elongated profile is fitted with a handle that is substantially perpendicular to its longitudinal axis. It serves as a support for a getting-up patient.

Mobilization handrail is constructed advantageously with servo-drive control for adjusting of the bed loading surface height, situated on the handle in position of the patient's thumb when he is grasping the handle.

Another useful version of mobilization handrail has the guide attached to the bottom part of the loading surface of the bed.

The mobilization handrail can have its guide formed simply by a casing with cross-section that nearly corresponds to cross-section of the elongated profile.

The mobilization handrail is advantageously equipped with a simple lock for the elongated profile in its vertical position. The lock consists of space that can be a part of the casing, into which the bottom part of the elongated profile is locked when the profile is set up in vertical position.

One of mobilization handrail variants is characterized by its elongated profile furnished with a fixture for a board, advantageously for dining board using bed head for the purpose.

Subject of the submitted invention is also a bed, primarily a hospital bed that is equipped with mobilization handrail at least on one of its sides.

It is more advantageous, if the bed is equipped with a pair of mobilization handrails at least on one side.

### BRIEF DESCRIPTION OF DRAWINGS

Invention is more closely described on the drawings, where

FIG. 1 shows axonometric view of bed with a straight loading surface of the bed, with mobilization handrails set up in vertical positions.

FIG. 2 shows the side view of bed with straight loading surface of the bed, with mobilization handrails set up in vertical positions, with possibility of setting the loading surface of the bed into the lowest, medium and the highest level according to patient's personal choice.

FIG. 3 shows the view of a patient getting up from right side of the bed equipped with two mobilization handrails.

FIG. 4 shows axonometric view of bed with an articulated loading surface of the bed and with inserted dining board.

FIG. 5 shows the side view of the bed with articulated loading surface of the bed with dining board inserted into the two mobilization handrails.

FIG. 6a presents the detail of mobilization handrail in slide-in position in the guide under the loading surface of the bed, FIG. 6b on the other hand presents mobilization handrail slide out from the guide. FIG. 6c shows position of mobilization handrail set up into its functional position before locking. FIG. 6d shows position of mobilization handrail set up into its functional position after locking.

FIG. 7 shows detail of dining board inserted into fixture in mobilization handrail.

FIG. 8 shows detail of switch that is placed on the handle of mobilization handrail that serves for adjusting of level of the loading surface of the bed by a patient.

### MODES FOR CARRYING OUT THE INVENTION

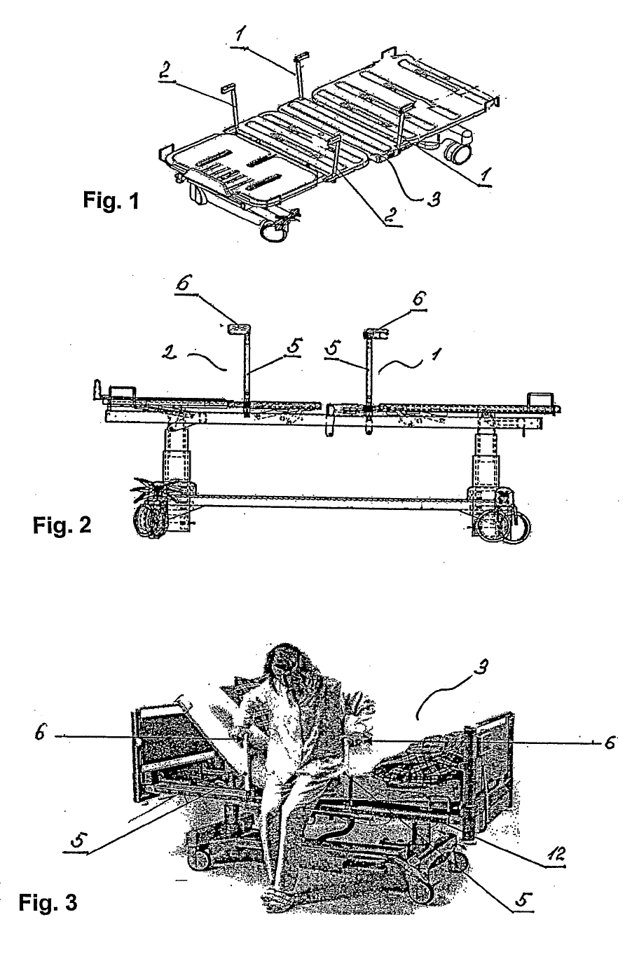

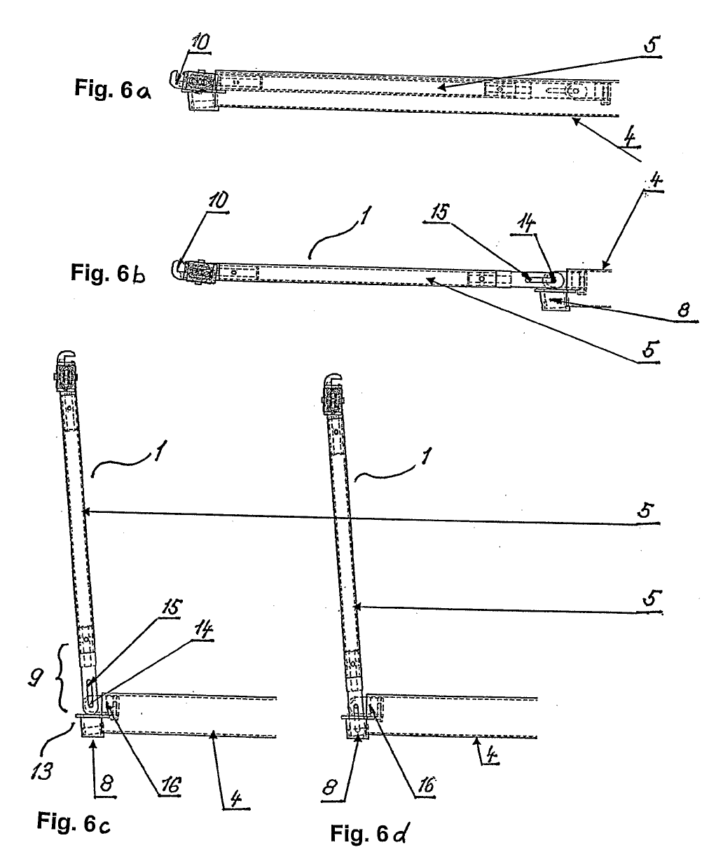

The bed 1 with a flat loading surface of the bed and with mobilization handrails 1 and 2, which are positioned and locked approximately in the vertical position, is illustrated in an axonometric view in the FIG. 1. The mobilization handrails 1 and 2, as shown in the FIG. 1, are equipped with holders 6, which are located on the elongated profile 5, for a support of a patient for his getting up from the bed 3. In the FIG. 2 there is illustrated a side view of the same bed 3 with a flat loading surface, with mobilization handrails 1 and 2 which are again locked in the vertical position. For illustration, the FIG. 2 schematically shows the design of bed 3 which allows setting the loading surface of the bed to the lowest, medium, and highest position according to personal choice of the patient. The FIG. 3 represents the view of a patient who is getting up from the right side 12 of the bed 3 with flat loading surface, which is equipped with two mobilization handrails 1 and 2 comprising of elongated profiles 5. In quiescent state, the elongated profiles 5 are in a rotary way connected with their inner parts 16 by means of the pivot 14 and they are telescopically inserted into the guides 4, which are in this case made as sleeves, see FIGS. 6a, b, c and d. The mobilization handrail 1 is shown in the FIG. 6a in fully inserted position, while in the FIG. 6b there is the mobilization handrail 1, which is protruding out from the guide 4 and is prepared for turning around the pivot 14 to the vertical position. The guides 4 or the sleeves or other components, which allow reversible motion of elongated profiles 5 and of their inner parts 16 in the direction of their axial axes, are located under the loading surface of the bed 3. A patient self, without any help from another person, can take out the mobilization handrails 1 and 2 from the sleeves to the position beyond the outlines of the bed 3, tilt them to vertical position and lock them by means of locking device 13, which is evident from the FIGS. 6c and 6d. It is formed by the bottom part 9 of the elongated profile 5 and locking space 8, which can be part of the guide 4. In the bottom part 9 of the elongated profile is a longitudinal aperture 15 oriented in the direction of the axial axis of the elongated profile 5, through which passes pivot 14 supported by the inner part 16 of the elongated profile 5, which remains in the guide 4 after extension of the elongated profile 5 and its end position in the guide 4 is limited, for instance by a backstop in order to prevent total extending of the elongated profile 5 from the guide 4. Following extension of mobilization handrail 1 and 2 or elongated profile 5, will turn it around pivot 14 into vertical position followed by bottom part 9 insertion by axial movement in the downward direction to the locking space 8. This motion is facilitated by the longitudinal aperture 15. The locking space 8 embraces the bottom part 9 of the elongated profile 5, fixing it in this way in a given position. During the insertion of the mobilization handrail 1 and 2, or of the elongated profile 5, backward into the guide 4 under the loading surface of the bed, it is lifted in its axial direction, tilts around the pivot 14 and slides into the guide 4.

In the course of activation of mobilization handrails 1 and 2, when the frame of the loading surface of the bed 3 is for example, at the lowest position and the back part is lifted to the upper position, which is a suitable position for leaving the bed 3, a patient first manipulates the mobilization handrail 1 and 2. After the patient sits up and lowers the legs from the bed 3, he/she then lifts the mobilization handrails 1 and 2 located conveniently under bed 3, under the part on which the patient's thighs rest. When getting up, the patient can lean against holders 6 located at the upper end of the mobilization handrails 1 and 2. At the end of holders 6, opposite thumbs of a patient, there are located drivers 7 by which a patient can control servo-drives and set the loading surface of the bed 3 to a height allowing the patient to get up comfortably, as the FIGS. 2 and 3 show.

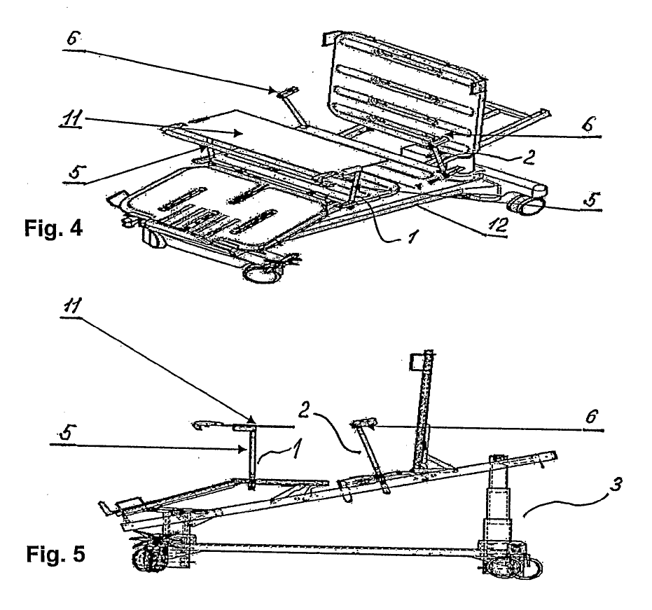

The mobilization handrails 1 and 2 can be located on both sides 12 of the bed 3, from both sides of the firm part of the loading surface, and from both sides of femoral part of the loading surface, altogether two pairs, as the FIGS. 1, 2, 4 and 5 depict, or they can be fixed only on one side of the bed 3, as shown in FIG. 3. If two pairs are fitted, a patient is able to get up from both sides of the bed 3, and if only one pair is used, then a patient can get up from bed 3 only to one side of it.

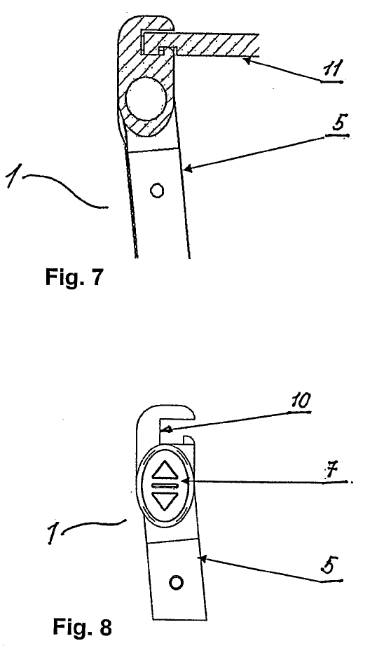

However, the mobilization handrails 1 and 2 can fulfill yet another function, for which it is necessary to fix all four handrails 1 and 2. They enable to install a dining board 11 right on the bed 3 by inserting the dining board 11, formed by a head of the bed 3, into two opposite mobilization handrails 1 and 2 at the firm part of the loading surface of the bed. In that way the dining board 11 is created right next to a patient by using components, which are standard parts of the bed 3. The FIG. 7 illustrates detail of the inserted dining board 11 into the fixture 10 in the mobilization handrail 1 and 2. Here the fixture 10 is realized in the form of the groove. FIG. 8 shows the detail of the driver 7 for control of servo-drive by a patient and in that way the height of the loading surface of the bed.

### INDUSTRIAL APPLICABILITY

The submitted invention represents a non-traditional realization of the mobilization handrail, which is designated for hospital facilities, in future even for social and senior care. The main utilization in hospital segment is supposed in standard bed wards. Applicability of these handrails in other sectors is assumed on beds that are used in private sanatoriums and clinics, in retirement homes, social care homes, and other institutions for social and senior care, or for home care for a patient. The mobilization handrail 1 and 2 according to the submitted invention allows safe and comfortable getting-up from bed, sitting down again and lying down, and so it increases self-sufficiency of a patient.

1. A mobilization handrail which is controllable by a patient without help of medical staff, comprising:
an elongated profile; and
a guide, wherein said elongated profile is placed in said guide for inserting and drawing-out of the elongated profile into and from a space underneath a loading surface of a bed to which the guide is mounted, wherein the elongated profile is arranged for positioning in substantially vertical position after its drawing-out from the space under the loading surface of the bed, said elongated profile being equipped with a locking device for stabilization in the substantially vertical position, wherein the elongated profile is telescopically insertable into and drawable from said guide along substantially its whole length, wherein said elongated profile includes a bottom part, and in the bottom part of the elongated profile an longitudinal aperture is provided which is oriented in the direction of the axial axis of the elongated profile, and further including a pivot which passes through the longitudinal aperture which pivot pivotally connects the elongated profile with said guide and wherein said elongated profile includes an inner part which is configured such that the inner part of the elongated profile remains in the guide after extension of the elongated profile resulting from drawing out from the space under the loading surface of the bed, the locking device comprises of comprising a locking space for receiving of the bottom part of the elongated profile after it has been drawn out and set into a substantially vertical position and thereby stabilized in the substantially vertical position.

2. The mobilization handrail according to claim 1, wherein the elongated profile is equipped with a holder that is oriented substantially perpendicular to said axial axis to provide support to a patient when getting up from the bed.

3. The mobilization handrail according to claim 2, said holder further including a driver of a servo-drive for setting of the height of the loading surface of the bed at the place of the thumb of a patient when gripping the holder.

4. The mobilization handrail according to claim 1, wherein the loading surface of the bed has a bottom part and the guide is mounted on the bottom part of the loading surface of the bed.

5. The mobilization handrail according to claim 1, wherein the guide is formed by a sleeve with a cross-section corresponding to the cross-section of the elongated profile.

6. The mobilization handrail according to claim 1, wherein the elongated profile is equipped with a fastening fixture for a board.

7. The mobilization handrail according to claim 1, further including a bed having a plurality of sides, wherein at least on one of the sides of the bed at least one mobilization handrail are placed.

8. The mobilization handrail according to claim 7, wherein at least on one of the sides a pair of the mobilization handrails are placed.

9. A mobilization handrail adapted for mounting to the bed of a patient, the bed having a loading surface which is elevated to provide a space therebeneath, said mobilization handrail comprising:
an elongated profile including an inner part and a bottom part and having a longitudinal axis;
a guide into which the elongated profile is received, said guide being coupled to the bed for enabling shifting of the elongated profile between a first position underneath the loading surface of the bed and a second position in which the elongated profile is positioned in a substantially vertical orientation;
said elongated profile including a locking device operatively connecting the elongated profile to the guide for retaining the elongated profile in said substantially vertical orientation in said second position,
wherein said elongated profile is telescopically shiftable into and out of said guide,
wherein said bottom part includes a longitudinal aperture oriented in the direction of the longitudinal axis, said elongated profile further including a pivot member extending through the longitudinal aperture, said pivot member pivotally connecting the inner part of the elongated profile to the guide after the elongated profile is telescopically shifted out of said guide, and
wherein said locking device includes a locking space complementally configured for receiving therein the bottom part of the elongated profile after the elongated profile has been telescopically drawn out of said guide and pivoted into said second position and for stabilizing the elongated profile in the second position.

10. The mobilization handrail according to claim 9, wherein said elongated profile further includes a handle oriented substantially perpendicular to the longitudinal axis and adapted for grasping by the patient when on or adjacent the bed.

11. The mobilization handrail of claim 9, said handle further including a control for actuation of a driving mechanism for setting the height of the loading surface of the bed.

12. The mobilization handrail of claim 11, wherein said control is positioned adjacent a thumb of the patient when said handle is grasped by the patient.

13. The mobilization handrail of claim 9, wherein the loading surface of the bed has a bottom side and said guide is mounted on the bottom side.

14. The mobilization handrail of claim 9, wherein the guide includes a sleeve having a cross-sectional configuration complemental to a cross-sectional configuration of the elongated profile.

15. The mobilization handrail of claim 9, wherein the elongated profile includes a fastening fixture configured for mounting a board thereto.

16. A bed having a plurality of sides and loading surface which is elevated to provide a space therebeneath, wherein the improvement comprises:
a mobilization handrail mounted adjacent to at least one of the sides of the bed, said
mobilization handrail comprising:
an elongated profile including an inner part and a bottom part and having a longitudinal axis;
a guide into which the elongated profile is received, said guide being coupled to the bed for enabling shifting of the elongated profile between a first position underneath the loading surface of the bed and a second position in which the elongated profile is positioned in a substantially vertical orientation,
wherein said elongated profile includes a locking device operatively connecting the elongated profile to the guide for retaining the elongated profile in said substantially vertical orientation in said second position,
wherein said elongated profile is telescopically shiftable into and out of said guide,
wherein said bottom part includes a longitudinal aperture oriented in the direction of the longitudinal axis, said elongated profile further including a pivot member extending through the longitudinal aperture, said pivot member pivotally connecting the inner part of the elongated profile to the guide after the elongated profile is telescopically shifted out of said guide, and
wherein said locking device includes a locking space complementally configured for receiving therein the bottom part of the elongated profile after the elongated profile has been telescopically drawn out of said guide and pivoted into said second position and for stabilizing the elongated profile in the second position.

17. The bed according to claim 16, wherein a plurality of said mobilization handrails are mounted to said bed and positioned adjacent said one side.
